(19) United States
(12) Patent Application Publication
(10) Pub. No.: US 2012/0281167 A1
(43) Pub. Date: Nov. 8, 2012

(54) Radiator Plate

(75) Inventor: Hitoshi NAKATSUKA, Daito-shi (JP)

(73) Assignee: Funai Electric Co., Ltd., Daito-shi (JP)

(21) Appl. No.: 13/454,721

(22) Filed: Apr. 24, 2012

(30) Foreign Application Priority Data
May 6, 2011 (JP) 2011-103378

(51) Int. Cl. G02F 1/13357; G09F 13/04; F28F 7/00

(52) U.S. Cl. 349/69; 165/185; 362/97.1

(57) ABSTRACT

This radiator plate includes a first surface and a second surface opposite to the first surface. A plurality of projecting portions each having an isosceles triangular cross-section are formed adjacent to each other on the first surface, and inclined surfaces of each of the projecting portions serve as heat radiation surfaces while a vertex angle θ of each of the projecting portions is set to be at least 90°.

### BACKGROUND OF THE INVENTION

1. Field of the Invention

The present invention relates to a radiator plate having excellent heat radiation performance, and more particularly, it relates to a radiator plate preferably employed to radiate heat of an LED or the like.

2. Description of the Related Art

A heat radiation member (heat sink) 100 having structure in which a plurality of fins 100a are vertically provided on a base 100b at constant intervals in FIG. 7 showing a related art is generally employed to radiate heat of a CPU, an IC, and other electronic components each having a large amount of heat generation. This heat radiation member 100 is bonded to the upper surface of an electronic component 101 with a thermal release tape 102 or the like. The heat radiation member 100 is employed to radiate heat conducted from the electronic component 101 to the fins 100a of the heat radiation member 100 by wind (convection of air) sent to the fins 100a from a cooling fan (not shown) inside a housing of a device.

Furthermore, a cooling fin including protrusions each having a cross-sectional shape (triangle, trapezoid, circular arc, rectangle, polygon, round, ellipse, streamline, or sinusoidal waveform, for example) in which at least a side of the cross-section is inclined and regularly staggered is known, as disclosed in Japanese Patent Laying-Open No. 2006-100293, for example.

A heat sink including a heat diffusion plate having a first surface connected with a heat generation element and Y-shaped heat radiation fins connected to a second surface of this heat diffusion plate, each having a heat radiation area of a head portion larger than that of a leg portion is also known, as disclosed in Japanese Patent Laying-Open No. 2006-210611, for example.

Although the heat radiation member 100 shown in FIG. 7 as the related art can efficiently radiate heat by sending wind from the cooling fan to the fins 100a and convecting air, heat radiation surfaces of the fins 100a are opposed to each other so that radiation heat radiated from the heat radiation surfaces of the fins 100a is reflected by heat radiation surfaces of adjacent fins 100a, remains between the fins 100a, and cannot be efficiently radiated, when heat is mainly radiated by the fins 100a without convection of air.

In addition, the size of the heat radiation member 100 having the plurality of fins 100a vertically provided is large, and hence it is difficult to employ the heat radiation member 100 as a heat radiation member radiating heat of LEDs, which are light sources, in an edge light type liquid crystal module incorporated into a current thin-screen liquid crystal television or the like that is small in width. On the other hand, when a plate-like heat radiation member having a small size with no fin is employed, a large amount of heat generated from LEDs cannot be efficiently radiated due to the small heat radiation area.

In the cooling fin according to the aforementioned Japanese Patent Laying-Open No. 2006-100293 including the protrusions each having the cross-sectional shape in which the side of the cross-section is inclined and regularly staggered, the heat radiation efficiency is improved due to the large heat radiation area, but heat radiated from the inclined surfaces of the protrusions is reflected or blocked by adjacent protrusions, and not sufficiently radiated. Thus, the heat radiation function of the cooling fin cannot be sufficiently exhibited.

Also in the heat sink according to the aforementioned Japanese Patent Laying-Open No. 2006-210611 in which a plurality of Y-shaped heat radiation fins each having the heat radiation area of the head portion larger than that of the leg portion are provided on the second surface of the heat diffusion plate, the heat radiation efficiency is improved due to the large heat radiation area, but the heat radiation function of the heat sink cannot be sufficiently exhibited. Furthermore, the size of the heat sink is large, and hence it is difficult to employ the heat sink as a heat radiation member radiating heat of LEDs of a liquid crystal module.

### SUMMARY OF THE INVENTION

The present invention has been proposed in order to solve the aforementioned problem, and an object of the present invention is to provide a radiator plate having a large heat radiation area, capable of exhibiting the excellent heat radiation function thereof without convection of air, and preferably employed to radiate heat of an LED in a liquid crystal module or the like due to the small size.

In order to attain the aforementioned object, a radiator plate according to a first aspect of the present invention includes a first surface and a second surface opposite to the first surface, a plurality of projecting portions each having an isosceles triangular cross-section are formed adjacent to each other on the first surface, and inclined surfaces of each of the projecting portions serve as heat radiation surfaces while a vertex angle θ of each of the projecting portions is set to be at least 90°.

In the radiator plate according to the first aspect of the present invention, as hereinabove described, the plurality of projecting portions each having the isosceles triangular cross-section are formed adjacent to each other on the first surface, and the inclined surfaces of each of the projecting portions serve as the heat radiation surfaces, whereby the heat radiation area can be increased as compared with a plate-like radiator plate. Furthermore, the vertex angle θ of each of the projecting portions is set to be at least 90° as in the radiator plate of the present invention, whereby radiation heat vertically radiated from the inclined heat radiation surfaces of each of the projecting portions is inhibited from being reflected or blocked by inclined heat radiation surfaces of adjacent projecting portions. Therefore, the excellent heat radiation function of the radiator plate can be exhibited without convection of air. The vertex angle θ of each of the projecting portions is at least 90°, so that the height of each of the projecting portions is not so high, and the size of the radiator plate is rendered smaller than that of a heat radiation member having fins vertically provided. Consequently, the radiator plate can be preferably employed as a radiator plate radiating heat of an LED, which is a light source, in an edge light type liquid crystal module incorporated into a thin-screen liquid crystal television or the like that is small in width.

In the aforementioned radiator plate according to the first aspect, the vertex angle θ of each of the projecting portions is preferably at least 90° and less than 180°. According to this structure, the heat radiation area can be easily increased to improve the heat radiation efficiency while an increase in the size of the radiator plate is inhibited.

In the aforementioned radiator plate according to the first aspect, the second surface is preferably mounted with an LED, and the radiator plate is preferably employed as a wiring substrate of the LED and configured to radiate heat of the LED. According to this structure, the heat of the LED can be efficiently radiated while an increase in the size of the wiring substrate is inhibited.

In this case, the radiator plate is preferably configured to be incorporated into a backlight unit of a liquid crystal module in a state where the second surface is mounted with the LED. According to this structure, the heat of the LED employed in the backlight of the liquid crystal module can be efficiently radiated by the radiator plate.

In the aforementioned radiator plate according to the first aspect, the plurality of projecting portions preferably include a plurality of projections extending in a prescribed direction, arranged parallel to each other. According to this structure, the projecting portions can be easily formed parallel to each other with no space therebetween.

In this case, the plurality of projections are preferably formed to extend in a longitudinal direction of the radiator plate. According to this structure, the plurality of projections can be easily formed along the longitudinal direction of the radiator plate.

In the aforementioned radiator plate according to the first aspect, the plurality of projecting portions preferably include protrusions each in the form of a pyramid, arranged adjacent to each other in a longitudinal direction and a transverse direction in plan view. According to this structure, the projecting portions can be easily formed adjacent to each other in the longitudinal direction and the transverse direction with no space therebetween.

In this case, the plurality of projecting portions preferably include protrusions each in the form of a square pyramid, arranged adjacent to each other in the longitudinal direction and the transverse direction in plan view. According to this structure, the projecting portions can be easily formed adjacent to each other in the longitudinal direction and the transverse direction in plan view.

The aforementioned radiator plate according to the first aspect preferably mainly contains aluminum. According to this structure, heat can be more efficiently radiated by the radiator plate mainly containing aluminum having excellent thermal conductivity.

In the aforementioned radiator plate according to the first aspect, the first surface is preferably formed with a film to improve heat radiation performance. According to this structure, heat can be more efficiently radiated from the first surface of the radiator plate.

In the aforementioned radiator plate according to the first aspect, the first surface is preferably treated to improve heat radiation performance. According to this structure, heat can be more efficiently radiated from the first surface of the radiator plate.

A display module according to a second aspect of the present invention includes a display panel, a backlight unit including an LED, and a radiator plate mounted with the LED, the radiator plate includes a first surface and a second surface opposite to the first surface, a plurality of projecting portions each having a triangular cross-section are formed adjacent to each other on the first surface, and inclined surfaces of each of the projecting portions serve as heat radiation surfaces while a vertex angle θ of each of the projecting portions is set to be at least 90°.

In the display module according to the second aspect of the present invention, as hereinabove described, the plurality of projecting portions each having the triangular cross-section are formed adjacent to each other on the first surface, and the inclined surfaces of each of the projecting portions serve as the heat radiation surfaces, whereby the heat radiation area can be increased as compared with a plate-like radiator plate. Furthermore, the vertex angle θ of each of the projecting portions is set to be at least 90° as in the radiator plate of the display module of the present invention, whereby radiation heat vertically radiated from the inclined heat radiation surfaces of each of the projecting portions is inhibited from being reflected or blocked by inclined heat radiation surfaces of adjacent projecting portions. Therefore, the excellent heat radiation function of the radiator plate can be exhibited without convection of air. The vertex angle θ of each of the projecting portions is at least 90°, so that the height of each of the projecting portions is not so high, and the size of the radiator plate is rendered smaller than that of a heat radiation member having fins vertically provided. Consequently, the radiator plate can be preferably employed as a radiator plate radiating heat of an LED, which is a light source, in an edge light type display module incorporated into a thin-screen display device or the like that is small in width.

In the aforementioned display module according to the second aspect, each of the projecting portions preferably has an isosceles triangular cross-section. According to this structure, the heat radiation area can be efficiently increased while an increase in the size of the radiator plate is inhibited, and hence heat of the LED can be efficiently radiated.

In the aforementioned display module according to the second aspect, the second surface of the radiator plate is preferably mounted with the LED, and the radiator plate is preferably configured to radiate heat of the LED. According to this structure, the heat of the LED is conducted from the second surface of the radiator plate to the first surface thereof, and hence the heat can be efficiently radiated from the first surface formed with the plurality of projecting portions.

In the aforementioned display module according to the second aspect, the plurality of projecting portions preferably include a plurality of projections extending in a prescribed direction, arranged parallel to each other. According to this structure, the projecting portions can be easily formed parallel to each other with no space therebetween.

In this case, the plurality of projections are preferably formed to extend in a longitudinal direction of the radiator plate. According to this structure, the plurality of projections can be easily formed along the longitudinal direction of the radiator plate.

In the aforementioned display module according to the second aspect, the plurality of projecting portions preferably include protrusions each in the form of a pyramid, arranged adjacent to each other in a longitudinal direction and a transverse direction in plan view. According to this structure, the projecting portions can be easily formed adjacent to each other in the longitudinal direction and the transverse direction with no space therebetween.

In this case, the plurality of projecting portions preferably include protrusions each in the form of a square pyramid, arranged adjacent to each other in the longitudinal direction and the transverse direction in plan view. According to this structure, the projecting portions can be easily formed adjacent to each other in the longitudinal direction and the transverse direction in plan view.

In the aforementioned display module according to the second aspect, the first surface of the radiator plate is preferably formed with a film to improve heat radiation performance. According to this structure, heat can be more efficiently radiated from the first surface of the radiator plate.

A liquid crystal module according to a third aspect of the present invention includes a liquid crystal panel, a backlight unit including an LED, and a radiator plate mounted with the LED, and the radiator plate includes a first surface and a second surface opposite to the first surface, a plurality of projecting portions each having a triangular cross-section are formed adjacent to each other on the first surface, and inclined surfaces of each of the projecting portions serve as heat radiation surfaces while a vertex angle θ of each of the projecting portions is set to be at least 90°.

In the liquid crystal module according to the third aspect of the present invention, as hereinabove described, the plurality of projecting portions each having the triangular cross-section are formed adjacent to each other on the first surface, and the inclined surfaces of each of the projecting portions serve as the heat radiation surfaces, whereby the heat radiation area can be increased as compared with a plate-like radiator plate. Furthermore, the vertex angle θ of each of the projecting portions is set to be at least 90° as in the radiator plate of the liquid crystal module of the present invention, whereby radiation heat vertically radiated from the inclined heat radiation surfaces of each of the projecting portions is inhibited from being reflected or blocked by inclined heat radiation surfaces of adjacent projecting portions. Therefore, the excellent heat radiation function of the radiator plate can be exhibited without convection of air. The vertex angle θ of each of the projecting portions is at least 90°, so that the height of each of the projecting portions is not so high, and the size of the radiator plate is rendered smaller than that of a heat radiation member having fins vertically provided. Consequently, the radiator plate can be preferably employed as a radiator plate radiating heat of an LED, which is a light source, in an edge light type liquid crystal module incorporated into a thin-screen liquid crystal television or the like that is small in width.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a partial perspective view of a radiator plate according to a first embodiment of the present invention as viewed from a front upper side;

FIG. 2 is a partial perspective view of the radiator plate as viewed from a rear upper side;

FIG. 3 is an enlarged sectional view of the radiator plate;

FIG. 4 is a sectional perspective view showing a radiator plate according to a second embodiment of the present invention;

FIG. 5 is a front elevational view of a liquid crystal module mounted with radiator plates according to a third embodiment of the present invention;

FIG. 6 is an enlarged partial sectional view taken along the line A-A in FIG. 5; and

FIG. 7 is a diagram for illustrating a related art heat sink.

### DESCRIPTION OF THE PREFERRED EMBODIMENTS

A radiator plate of the present invention is now described in detail with reference to the drawings.

### First Embodiment

In a first embodiment, a wiring substrate 2 of an LED bar 1 is utilized as a radiator plate P1.

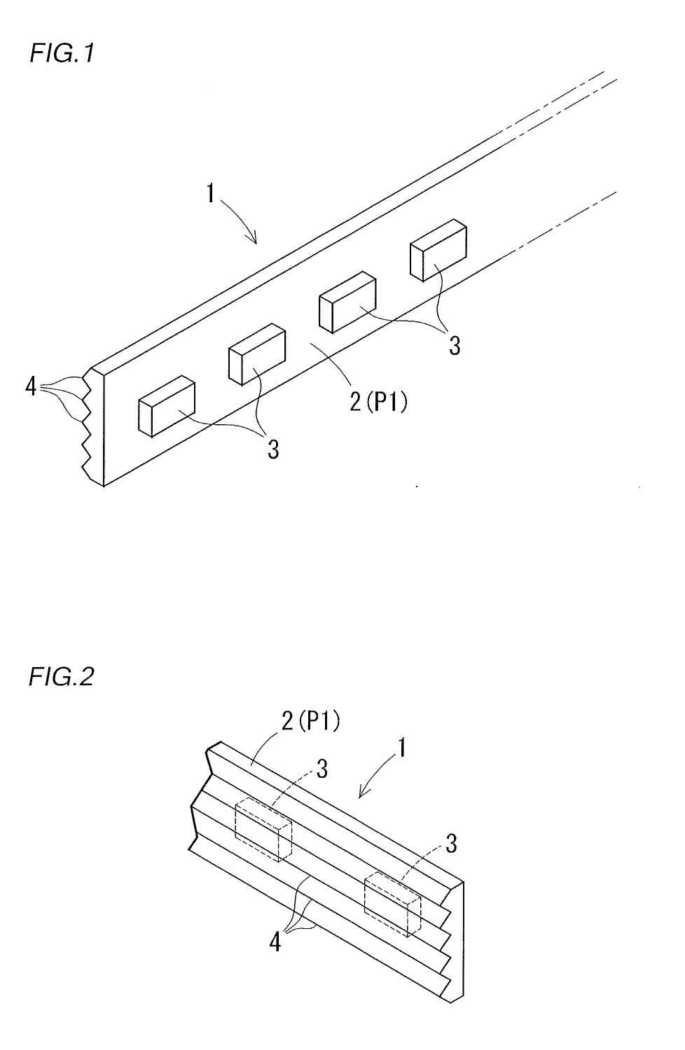

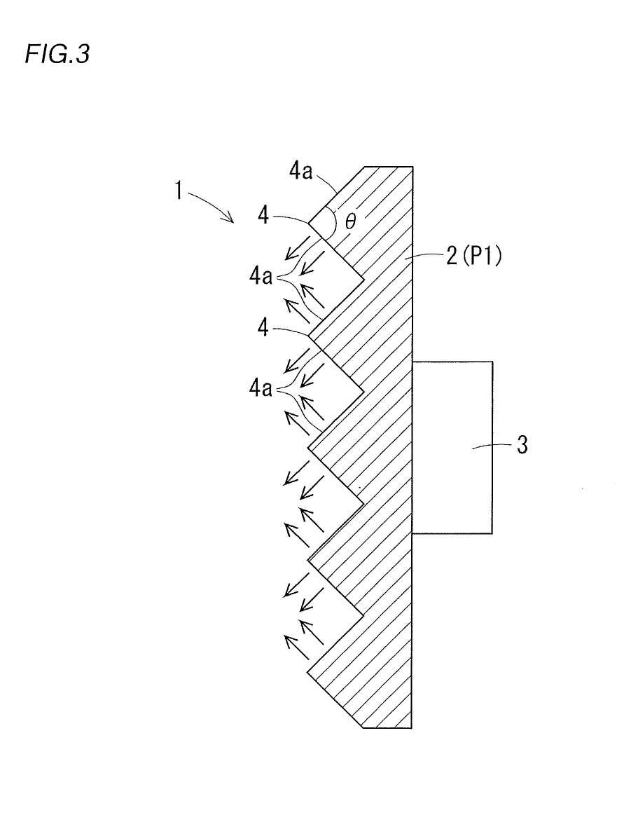

This LED bar 1 is mounted with a plurality of LEDs 3 serving as point light sources, as shown in FIG. 1. Specifically, the LEDs 3 are mounted on the front surface (surface on which wiring is formed) of the wiring substrate 2 having a rectangular shape in plan view, employing an aluminum core having excellent thermal conductivity. In other words, the LEDs 3 are mounted on the front surface of the wiring substrate 2 mainly containing aluminum. The plurality of LEDs 3 are arranged in line at constant intervals. As shown in FIGS. 1 to 3, a plurality of projections 4 extending in the longitudinal direction of the wiring substrate 2 are formed on the rear surface of the wiring substrate 2 serving as the radiator plate P1, as a plurality of projecting portions each having an isosceles triangular cross-section. The plurality of projections 4 are formed parallel and adjacent to each other over the entire length of the wiring substrate 2. As shown in FIG. 3, the inclined surfaces 4a of each of the projections 4 serve as heat radiation surfaces radiating heat conducted from the LEDs 3 to the wiring substrate 2. The front surface of the wiring substrate 2 is an example of the “a second surface” in the present invention, and the rear surface of the wiring substrate 2 is an example of the “first surface” in the present invention.

The vertex angle θ of each of the projections 4 is set to be at least 90° and less than 180°. When the vertex angle θ is set in this range, radiation heat vertically radiated from the inclined surfaces 4a of each of the projections 4 is neither reflected nor blocked by the inclined surfaces 4a of adjacent projections 4 so that the heat radiation function of the radiator plate P1 (wiring substrate 2) is improved. As the vertex angle θ is increased close to 180°, the heat radiation area of the rear surface of the radiator plate P1 (wiring substrate 2) is decreased due to planarization. In contrast, as the vertex angle θ is close to 90°, the heat radiation area of the rear surface of the radiator plate P1 is increased due to sharp corrugation. Therefore, in this first embodiment, the vertex angle θ of each of the projections 4 is set to be 90°, whereby the heat radiation area is square root of 2 times the heat radiation area in the case of a planarized surface, and the heat radiation action is further improved. If the vertex angle θ is set to be 90° or more, the height of each of the projections 4 is not so high, whereby the size of the radiator plate P1 (wiring substrate 2) is smaller than that of the related art heat sink 100 having the fins vertically provided on a mounting surface. Consequently, the radiator plate P1 can be easily incorporated into a backlight unit of a liquid crystal module.

As hereinabove described, the LED bar 1 having the wiring substrate 2 employed as the radiator plate P1 is incorporated along each of end surfaces of a light guide plate of the edge light type backlight unit into the liquid crystal module such as a liquid crystal television. The LED bar 1 is employed to cause the light guide plate to carry out surface emission with light entering the light guide plate from the LEDs 3. At this time, a large amount of heat generated from the LEDs 3 is quickly conducted to the aluminum core of the wiring substrate 2 having excellent thermal conductivity and radiated from the inclined surfaces 4a of each of the projections 4 formed on the rear surface of the wiring substrate 2. At this time, as described above, the radiation heat vertically radiated from the inclined surfaces 4a of each of the projections 4 is neither reflected nor blocked by the inclined surfaces 4a of the adjacent projections while the heat radiation area is increased, so that the excellent heat radiation function can be exhibited. Consequently, heat can be efficiently radiated without convection of air so that degradation of the LEDs 3 and a decrease in luminance of the LEDs 3 resulting from overheat of the LEDs 3 can be prevented.

According to the first embodiment, the vertex angle θ of each of the projecting portions is set to be at least 90° and less than 180°. Thus, the heat radiation area can be easily increased to improve the heat radiation efficiency while the increase in the size of the radiator plate P1 is inhibited.

According to the first embodiment, the radiator plate P1 is employed as the wiring substrate 2 of the LEDs 3 and configured to radiate heat of the LEDs 3. Thus, the heat of the LEDs 3 can be efficiently radiated while the increase in the size of the wiring substrate 2 is inhibited.

According to the first embodiment, the plurality of projections 4 are formed to extend in the longitudinal direction of the radiator plate P1, as the plurality of projecting portions. Thus, the projecting portions can be easily formed parallel to each other with no space therebetween.

According to the first embodiment, the wiring substrate 2 serving as the radiator plate P1 mainly contains aluminum. Thus, heat can be more efficiently radiated by the radiator plate P1 mainly containing aluminum having excellent thermal conductivity.

### Second Embodiment

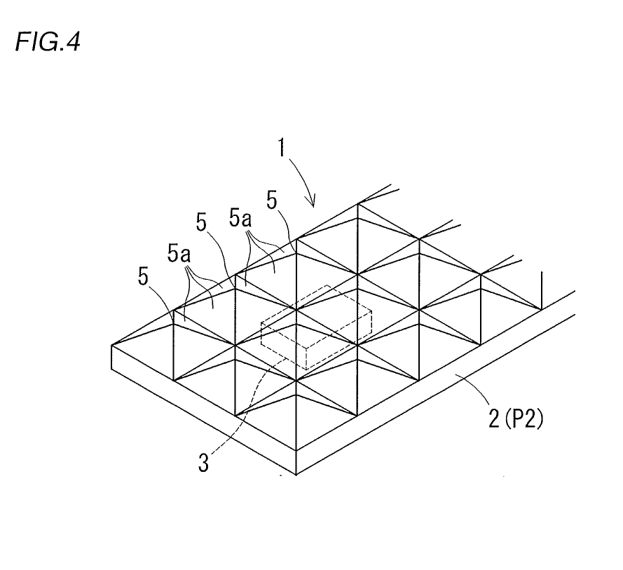

Also in this second embodiment, a wiring substrate 2 of an LED bar 1 is utilized as a radiator plate P2, as shown in FIG. 4. Specifically, a plurality of protrusions 5 each in the form of a square pyramid are formed on the rear surface of the radiator plate P2 (wiring substrate 2), as a plurality of projecting portions each having an isosceles triangular cross-section. The plurality of protrusions 5 each are in the form of a square pyramid having a vertex angle θ of at least 90° and less than 180°, and are arranged adjacent to each other in a longitudinal direction and a transverse direction. The remaining structure of the radiator plate P2 is similar to that of the radiator plate P1 according to the aforementioned first embodiment. Therefore, redundant description is not repeated.

Also in this radiator plate P2, radiation heat vertically radiated from the inclined surfaces 5a of each of the protrusions 5 is neither reflected nor blocked by the inclined surfaces 5a of adjacent protrusions 5 while the heat radiation area is increased, so that the excellent heat radiation function of the radiator plate P2 can be exhibited. Consequently, heat can be efficiently radiated without convection of air so that overheat of LEDs can be prevented.

According to the second embodiment, the protrusions each in the form of a square pyramid, arranged adjacent to each other in the longitudinal direction and the transverse direction in plan view are formed as the plurality of projecting portions. Thus, the projecting portions can be easily formed adjacent to each other in the longitudinal direction and the transverse direction with no space therebetween.

### Third Embodiment

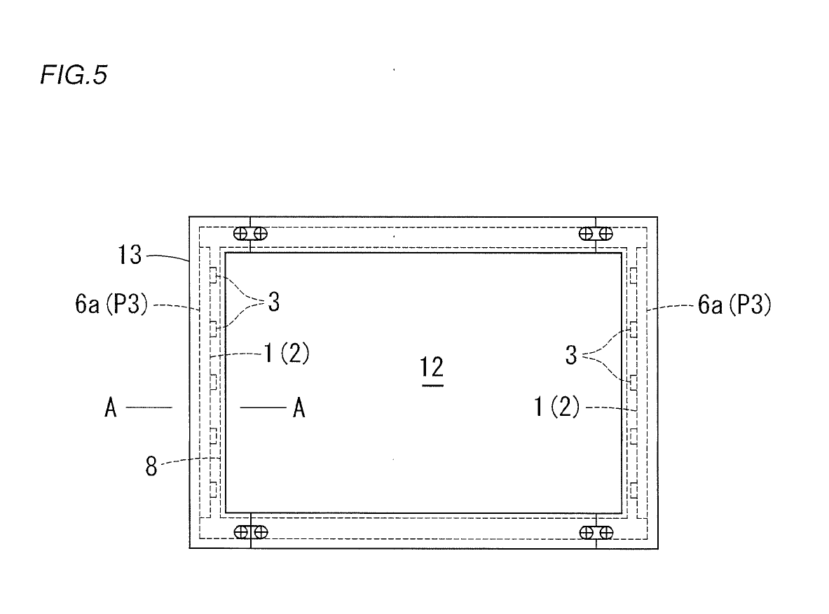

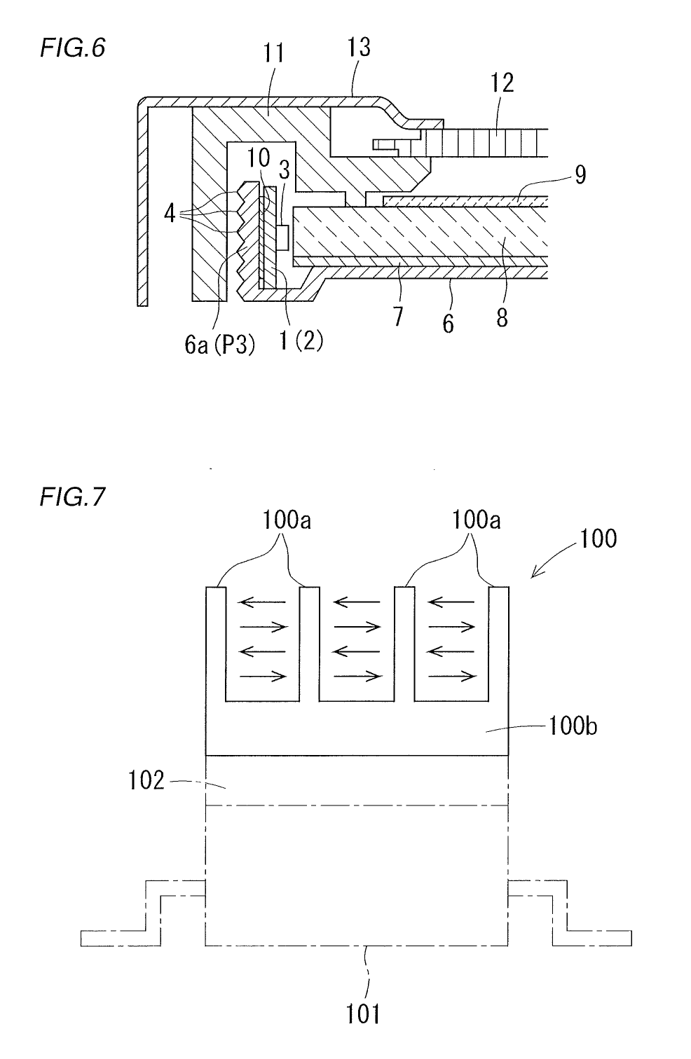

In a liquid crystal module according to a third embodiment, a light reflective sheet 7 (see FIG. 6), a light guide plate 8, and an optical sheet 9 (see FIG. 6) are provided on a rear frame 6 made of metal, and LED bars 1 each having LEDs 3 mounted on a wiring substrate 2 are arranged along end surfaces of the light guide plate 8, as shown in FIGS. 5 and 6. The LEDs 3 are arranged in line on the wiring substrate 2. As shown in FIG. 6, the LED bars 1 each are bonded onto the inner surface of a side plate 6a of the rear frame 6 through a heat radiation sheet 10. The liquid crystal module includes a backlight unit, and the backlight unit includes the LEDs 3, the wiring substrates 2, the side plates 6a of the rear frame 6, the light reflective sheet 7, the light guide plate 8, and the optical sheet 9. An end edge portion of the light guide plate 8 is pressed by a molded frame 11, a liquid crystal panel 12 is placed on the molded frame 11, and the periphery of the liquid crystal module is surrounded by a bezel 13. The liquid crystal module according to the third embodiment has the aforementioned structure, and the aforementioned side plate 6a of the rear frame 6 is employed as a radiator plate P3. The aforementioned plurality of projections 4 each having a vertex angle θ of at least 90° and less than 180° are formed parallel and adjacent to each other on the outer surface of the radiator plate P3 (side plate 6a), as a plurality of projecting portions each having an isosceles triangular cross-section. Thus, the inclined surfaces of each of the projections 4 become heat radiation surfaces. The outer surface of the aforementioned side plate 6a of the rear frame 6 is an example of the “first surface” in the present invention, and the inner surface of the aforementioned side plate 6a of the rear frame 6 is an example of the “second surface” in the present invention.

The side plate 6a of the rear frame 6 of the liquid crystal module is employed as the radiator plate P3, whereby heat generated in the LEDs 3 mounted on each of the LED bars 1 is conducted to the radiator plate P3 (side plate 6a) through the wiring substrate 2 and the heat radiation sheet 10, and efficiently radiated from the inclined surfaces of each of the projections 4 of the radiator plate P3 without convection of air, as described above. Thus, degradation of the LEDs 3 and a decrease in luminance of the LEDs 3 resulting from overheat of the LEDs 3 can be prevented.

Although the present invention has been described and illustrated in detail, it is clearly understood that the same is by way of illustration and example only and is not to be taken by way of limitation, the spirit and scope of the present invention being limited only by the terms of the appended claims.

While the aforementioned protrusions 5 each in the form of a square pyramid are formed as the projecting portions each having an isosceles triangular cross-section in the aforementioned second embodiment, the present invention is not restricted to this but protrusions each in the form of a regular hexagonal pyramid, for example, or protrusions each having a shape other than a square pyramid and a regular hexagonal pyramid may alternatively be formed as the projecting portions each having an isosceles triangular cross-section. At this time, protrusions each in the form of a pyramid may alternatively be staggered adjacent to each other.

Furthermore, the rear surfaces of the radiator plate P1 according to the aforementioned first embodiment and the radiator plate P2 according to the aforementioned second embodiment may alternatively be treated with alumite as a surface treatment in order to further improve heat radiation performance. Thus, heat can be more efficiently radiated from the rear surfaces of the radiator plates P1 and P2. Furthermore, a coating film having excellent heat radiation performance may alternatively be formed on the rear surfaces of the radiator plates P1 and P2. Thus, heat can be more efficiently radiated from the rear surfaces of the radiator plates P1 and P2.

In the aforementioned third embodiment, protrusions 5 (see FIG. 4) similar to that shown in the aforementioned second embodiment may alternatively be formed adjacent to each other in a longitudinal direction and a transverse direction instead of the projections 4. Obviously, a coating film to further improve heat radiation performance may alternatively be formed on the outer surface of the radiator plate P3 as necessary. Thus, heat can be more efficiently radiated from the outer surface of the radiator plate P3.

While the projecting portions each having an isosceles triangular cross-section are shown as an example of the projecting portions in the present invention in each of the aforementioned first to third embodiments, the present invention is not restricted to this. Projecting portions each having a cross-section in the form of a triangle other than an isosceles triangle may alternatively be employed.

While the liquid crystal module is shown as an example of the display module in the present invention in the aforementioned third embodiment, the present invention is not restricted to this. A display module other than the liquid crystal module may alternatively be employed.

What is claimed is:

1. A radiator plate comprising:
a first surface; and
a second surface opposite to said first surface, wherein
a plurality of projecting portions each having an isosceles triangular cross-section are formed adjacent to each other on said first surface, and
inclined surfaces of each of said projecting portions serve as heat radiation surfaces while a vertex angle θ of each of said projecting portions is set to be at least 90°.

2. The radiator plate according to claim 1, wherein
said vertex angle θ of each of said projecting portions is at least 90° and less than 180°.

3. The radiator plate according to claim 1, wherein
said second surface is mounted with an LED,
said radiator plate employed as a wiring substrate of said LED and configured to radiate heat of said LED.

4. The radiator plate according to claim 3, configured to be incorporated into a backlight unit of a liquid crystal module in a state where said second surface is mounted with said LED.

5. The radiator plate according to claim 1, wherein
said plurality of projecting portions comprise a plurality of projections extending in a prescribed direction, arranged parallel to each other.

6. The radiator plate according to claim 5, wherein
said plurality of projections are formed to extend in a longitudinal direction of said radiator plate.

7. The radiator plate according to claim 1, wherein
said plurality of projecting portions comprise protrusions each in the form of a pyramid, arranged adjacent to each other in a longitudinal direction and a transverse direction in plan view.

8. The radiator plate according to claim 7, wherein
said plurality of projecting portions comprise protrusions each in the form of a square pyramid, arranged adjacent to each other in said longitudinal direction and said transverse direction in plan view.

9. The radiator plate according to claim 1, mainly containing aluminum.

10. The radiator plate according to claim 1, wherein
said first surface is formed with a film to improve heat radiation performance.

11. The radiator plate according to claim 1, wherein
said first surface is treated to improve heat radiation performance.

12. A display module comprising:
a display panel;
a backlight unit including an LED; and
a radiator plate mounted with said LED, wherein
said radiator plate includes a first surface and a second surface opposite to said first surface,
a plurality of projecting portions each having a triangular cross-section are formed adjacent to each other on said first surface, and
inclined surfaces of each of said projecting portions serve as heat radiation surfaces while a vertex angle θ of each of said projecting portions is set to be at least 90°.

13. The display module according to claim 12, wherein
each of said projecting portions has an isosceles triangular cross-section.

14. The display module according to claim 12, wherein
said second surface of said radiator plate is mounted with said LED, and
said radiator plate is configured to radiate heat of said LED.

15. The display module according to claim 12, wherein
said plurality of projecting portions comprise a plurality of projections extending in a prescribed direction, arranged parallel to each other.

16. The display module according to claim 15, wherein
said plurality of projections are formed to extend in a longitudinal direction of said radiator plate.

17. The display module according to claim 12, wherein
said plurality of projecting portions comprise protrusions each in the form of a pyramid, arranged adjacent to each other in a longitudinal direction and a transverse direction in plan view.

18. The display module according to claim 17, wherein
said plurality of projecting portions comprise protrusions each in the form of a square pyramid, arranged adjacent to each other in said longitudinal direction and said transverse direction in plan view.

19. The display module according to claim 12, wherein
said first surface of said radiator plate is formed with a film to improve heat radiation performance.

20. A liquid crystal module comprising:
a liquid crystal panel;
a backlight unit including an LED; and
a radiator plate mounted with said LED, wherein
said radiator plate includes a first surface and a second surface opposite to said first surface,
a plurality of projecting portions each having a triangular cross-section are formed adjacent to each other on said first surface, and
inclined surfaces of each of said projecting portions serve as heat radiation surfaces while a vertex angle θ of each of said projecting portions is set to be at least 90°.
